(19) United States
(12) Patent Application Publication
(10) Pub. No.: US 2013/0057218 A1
(43) Pub. Date: Mar. 7, 2013

(54) DEVICE AND METHOD FOR CONTROLLING CHARGE OF ASSEMBLED BATTERY

(71) Applicants: Tomohiro Sawayanagi, Nagano (JP); Naoki Kitahara, Nagano (JP)

(72) Inventors: Tomohiro Sawayanagi, Nagano (JP); Naoki Kitahara, Nagano (JP)

(73) Assignee: OMRON AUTOMOTIVE ELECTRONICS CO., LTD., Aichi (JP)

(21) Appl. No.: 13/600,981

(22) Filed: Aug. 31, 2012

(30) Foreign Application Priority Data
Sep. 1, 2011 (JP) 2011-190269

(51) Int. Cl. H02J 7/00

(52) U.S. Cl. 320/118

(57) ABSTRACT

An assembled-battery charge control device controls charge of an assembled battery including a plurality of secondary batteries connected in series. The assembled-battery charge control device includes a discharge circuit that includes a series circuit of a resistor and a switching element, the series circuit being connected in parallel with each battery of the assembled battery, and the discharge circuit allowing the battery corresponding to the switching element to discharge by turning on the switching element. The assembled-battery charge control device also includes voltage detection unit that detects a voltage at each battery of the assembled battery and a control unit that determines the battery that needs suppression of the charge based on the voltage at each battery detected by the voltage detection unit, and turns on the switching element corresponding to the battery.

### BACKGROUND OF THE INVENTION

1. Technical Field

The present invention relates to a charge control technology of reducing a variation in voltage among batteries constituting an assembled battery.

2. Related Art

For example, an electric automobile is provided with a high-voltage battery serving as a power supply for a drive motor and a in-vehicle device. Generally the high-voltage battery is constructed by so-called an assembled battery in which a plurality of secondary batteries, such as lithium-ion batteries, are connected in series. In the assembled battery, dischargeable electric energy (hereinafter referred to as a “discharge capacity”) varies among the batteries due to a variation in battery characteristic of each battery. For the secondary battery, since a battery life is shortened by overcharge or over discharge, once one of the batteries constituting the assembled battery comes into a charge completed state or in a discharge completed state, it is necessary to stop a charge operation or a discharge operation as a whole.

Therefore, during the discharge, when the battery having the smallest discharge capacity completes the discharge, the discharge operation of the whole assembled battery stops while other batteries do not complete the discharge. On the other hand, during the charge, before the battery that has fully been discharged during the discharge does not come into the charge completed state, the battery that has not fully been discharged during the discharge comes into the charge completed state, and the charge operation of the whole assembled battery is stopped. When such operations are repeated, the battery having the small discharge capacity always falls into a poor charge state, and the discharge capacity thus decreases as the whole assembled battery.

A well-known method is taken as a measure, for example, disclosed in Japanese Unexamined Patent Publication Nos. 6-253463, 8-19188, 2000-83327, 7-264780, and 2002-233069. In the method, a discharge circuit constructed by a series circuit of a switching element and a resistor is connected in parallel with each battery constituting the assembled battery, and on/off control of the switching element is performed according to the charge state of each battery. According to the method, the switching element is turned on to suppress the charge for the battery having the high voltage, and the switching element is turned off to preferentially perform the charge for the battery having the low voltage. Therefore, the batteries can be charged in a balanced manner, and a decrease in discharge capacity of the whole assembled battery can be suppressed.

Japanese Unexamined Patent Publication No. 2010-148242 discloses a technology in which a converter is provided in each battery constituting the assembled battery, and the switching element of the converter is turned on and off using a PWM signal according to the voltage at the battery. According to the technology, the outputs of the batteries can be equalized by adjusting a duty of the PWM signal.

FIG. 5 is a view schematically illustrating charge control of the assembled battery. FIG. 5A illustrates a pre-charge state, FIG. 5B illustrates a currently charging state, and FIG. 5C illustrates a state in which the charge is completed. When the charge is started from the state in which the voltages of batteries B1 to B4 vary as illustrated in FIG. 5A, the voltages of the batteries B1 to B4 rise as illustrated in FIG. 5B. At this point, for the batteries B1, B2, and B4 having the voltages higher than a target voltage (in this case, the lowest voltage at the battery B3) shown in a dashed line, the switching element is turned on to perform the discharge, thereby suppressing the charge. On the other hand, for the battery B3, the switching element is put into the off state. This preferentially charges the battery B3. Finally, when the battery B2 having the highest voltage reaches a full charge as illustrated in FIG. 5C, the charge of other batteries are also ended. At this point, variation in voltage among the batteries B1 to B4 decreases.

In the case where the switching element is turned on to perform the discharge, a discharge current passes through a resistor connected in series with the switching element, and the resistor is thus heated. A passage of a large amount of discharge current through the resistor may bring the resistor into a high temperature and a burnout. Therefore, in a high-temperature range, the discharge circuit is used such that a rated power of 100% is not applied to the resistor but the power applied to the resistor is reduced with increasing temperature.

Specifically, FIG. 6 illustrates an example of a load reduction curve of the resistor. In FIG. 6, a horizontal axis indicates the temperature, and a vertical axis indicates a rated power ratio. The rated power ratio is a ratio of the power that can be applied to the resistor with respect to the rated power of 100% of the resistor. In the example in FIG. 6, although the rated power of 100% can be applied to the resistor up to the temperature of 70° C., the power to be applied to the resistor reduces according to the temperature rise when the temperature exceeds 70° C. For example, at the temperature of 100° C., the rated power ratio is 50%, and the power applicable to the resistor becomes a half of the rated power.

Because the power applicable to the resistor is restricted by the temperature, a current passing through the resistor is also restricted. On the other hand, preferably the discharge current passes through the resistor as much as possible from the viewpoint of equalizing the voltages at the batteries constituting the assembled battery in a short time. However, it is necessary to use the resistor having the large rated power. In the example in FIG. 6, it is necessary to use the resistor having the double rated power in order to pass the same current as that in the use of the rated power at the temperature of 100° C.

### SUMMARY

One or more embodiments of the present invention provide a device and a method for controlling the charge of the assembled battery, in which the voltages at the batteries can be equalized for a short time even if the resistor having the large rated power is not used.

In accordance with one aspect of the present invention, an assembled-battery charge control device includes: a discharge circuit that includes a series circuit of a resistor and a switching element, the series circuit being connected in parallel with each battery of the assembled battery, the discharge circuit allowing the battery corresponding to a switching element to discharge by turning on the switching element; a voltage detection unit that detects a voltage at each battery of the assembled battery; and a control unit that determines the battery that needs suppression of charge based on the voltage at each battery detected by the voltage detection unit, and turns on the switching element corresponding to the battery. The control unit, when the voltage at the battery that needs suppression of the charge is less than a predetermined reference voltage, puts the switching element corresponding to the battery into an on state for a first time frame, and the control unit, when the voltage at the battery that needs the suppression of the charge is greater than or equal to the reference voltage, puts the switching element corresponding to the battery into the on state for a second time frame shorter than the first time frame.

Accordingly, since the voltage at each battery is less than the reference voltage immediately after the charge is started, an on time frame of the switching element is lengthened, so that a large amount of discharge current passes through the resistor. Therefore, the charge of the battery having the high voltage is suppressed, and the battery having the low voltage is preferentially charged, so that the variation in voltage among the batteries can be corrected in an early stage. On the other hand, when a time sufficiently elapses from the start of the charge, the voltage at each battery is greater than or equal to the reference voltage. Therefore, the on time frame of the switching element is shortened to reduce the discharge current passing through the resistor. As a result, consumed power decreases at the resistor to suppress heat generation of the resistor. The on time frame of the switching element is switched according to the voltage at the battery. Therefore, the large amount of discharge current passes through the resistor immediately after the charge is started, and the discharge current reduces with the progress of the charge, so that the voltages at the batteries can be equalized for a short time using the resistor having the small rated power.

According to one or more embodiments of the present invention, the control unit may control the switching element using a PWM signal. In this case, change of a duty of the PWM signal switches between the first time frame and the second time frame.

Further, according to one or more embodiments of the present invention, the control unit may set a target voltage based on the voltage at each battery detected by the voltage detection unit, the control unit may put the switching element corresponding to the battery into the on state for the first or second time frame when the voltage at one of the batteries is greater than or equal to a voltage, in which a constant value is added to the target voltage, while the control unit does not perform on/off control to each switching element, and the control unit may turn off the switching element corresponding to the battery when the voltage at the battery corresponding to the switching element that is in the on state for the first or second time frame is less than the target voltage while the control unit performs the on/off control to each switching element.

Furthermore, according to one or more embodiments of the present invention, the reference voltage may include a first reference voltage and a second reference voltage lower than the first reference voltage, the control unit may switch an on time frame of the switching element to the second time frame when the voltage at the battery corresponding to the switching element in which the on time frame is the first time frame is greater than or equal to the first reference voltage, and the control unit may switch the on time frame of the switching element to the first time frame when the voltage at the battery corresponding to the switching element in which the on time frame is the second time frame is less than the second reference voltage.

In accordance with another aspect of the present invention, an assembled-battery charge control method includes: detecting a voltage at each battery of an assembled battery; determining the battery that needs suppression of charge based on the detected voltage at each battery; putting the switching element corresponding to the battery into an on state for a first time frame when the voltage at the battery that needs the suppression of the charge is less than a predetermined reference voltage; and putting the switching element corresponding to the battery into the on state for a second time frame shorter than the first time frame when the voltage at the battery that needs the suppression of the charge is greater than or equal to the reference voltage.

According to one or more embodiments of the invention, the large amount of discharge current passes through the resistor immediately after the charge is started, and the discharge current reduces with the advance of the charge, so that the voltages at the batteries can be equalized for a short time even if the resistor having the large rated power is not used.

### BRIEF DESCRIPTION OF THE DRAWINGS

FIG. 1 is a block diagram illustrating an embodiment of the present invention;

FIG. 2 is a flowchart illustrating a charge control procedure;

FIG. 3 is a flowchart illustrating a duty switching procedure;

FIGS. 4A and 4B are waveform charts of a PWM signal;

FIGS. 5A, 5B, and 5C are views schematically illustrating charge control of an assembled battery; and

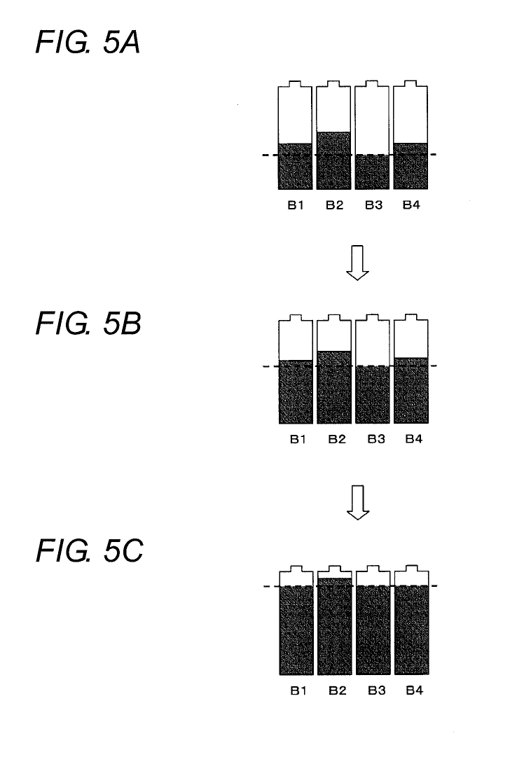

FIG. 6 is a view illustrating a load reduction curve of a resistor.

### DETAILED DESCRIPTION

Hereinafter embodiments of the present invention will be described with reference to the drawings. The case that the invention is applied to an assembled battery mounted on an electric automobile is cited by way of example.

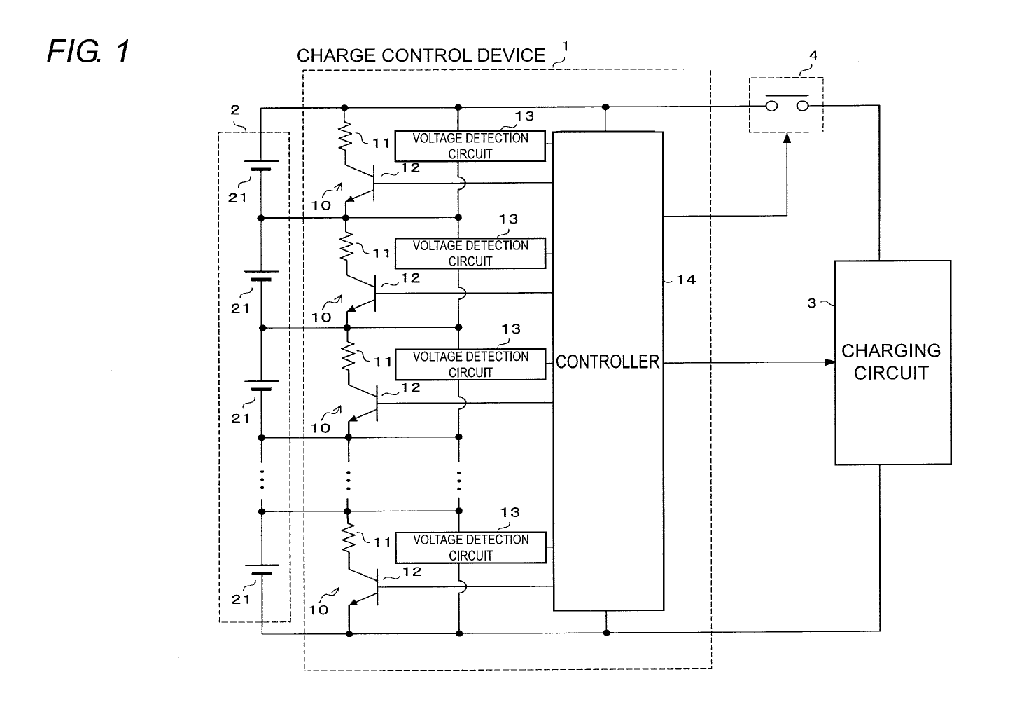

A configuration of a charge control device of the embodiment will be described with reference to FIG. 1. Referring to FIG. 1, a charge control device 1 is provided between an assembled battery 2 and a charging circuit 3 to control charge of the assembled battery 2. The assembled battery 2 includes a plurality of batteries 21 connected in series. For example, each battery 21 is a secondary battery, such as a lithium-ion battery. A contactor 4 is provided between the charge control device 1 and the charging circuit 3.

In the charge control device 1, each battery 21 of the assembled battery 2 includes a discharge circuit 10 that is constructed by a series circuit of a resistor 11 and a transistor 12 and a voltage detection circuit 13 that detects a voltage at the battery 21. A controller 14, which is common to the discharge circuits 10 and the voltage detection circuits 13, is provided. The controller 14 includes a CPU and a memory and the like. The transistor 12 is an example of the “switching element” of the present invention, and the voltage detection circuit 13 is an example of the “voltage detection unit” of the present invention. The controller 14 is an example of the “control unit” of the invention.

The discharge circuit 10 is connected in parallel with the battery 21. The discharge circuit 10 discharges the battery 21 corresponding to the transistor 12 by turning on the transistor 12. One end of the resistor 11 is connected to a positive electrode of the battery 21, and the other end of the resistor 11 is connected to a collector of the transistor 12. An emitter of the transistor 12 is connected to a negative electrode of the battery 21, and a base of the transistor 12 is connected to the controller 14. The voltage detection circuit 13 is connected between the positive electrode and the negative electrode of the battery 21. An output of the voltage detection circuit 13 is provided to the controller 14.

The controller 14 controls the transistor 12 based on a detected voltage of the voltage detection circuit 13. The controller 14 issues an instruction to the charging circuit 3 to start or stop the charge, turns on (closed state) the contactor 4 in starting the charge, and turns off (opened state) the contactor 4 in stopping the charge. Further, the controller 14 conducts communication with a superior apparatus (not illustrated).

Next, an outline of the charge control performed by the charge control device 1 will be described below. In response to an instruction from the superior apparatus, the controller 14 turns on the contactor 4 while issuing the instruction to the charging circuit 3. Therefore, the assembled battery 2 is charged from the charging circuit 3 through the contactor 4. The voltage at each battery 21 rises after the charge is started. At this point, as described above, the voltage varies among the batteries. Based on the output of each voltage detection circuit 13, the controller 14 monitors the voltage at each battery 21 to determine which battery needs the suppression of the charge. For example, the battery having the voltage higher than the minimum voltage of the voltages detected by the voltage detection circuit 13 is determined as the battery that needs the suppression of the charge.

The controller 14 turns on the transistor 12 of the discharge circuit 10 corresponding to the battery 21, which is determined as the battery that needs the suppression of the charge, for a predetermined period of time. In this case, the controller 14 provides a PWM (Pulse Width Modulation) signal to the base of the transistor 12, and the transistor 12 is in an on state while the PWM signal is at an H (High) level. When the transistor 12 is turned on, the charge of the battery 21 is suppressed, because a discharge pathway is formed by the resistor 11 and the transistor 12. On the other hand, because the transistor 12 is in an off state, the battery 21 that does not need the suppression of the charge is preferentially charged.

In the present embodiment, when turning on the transistor 12, the controller 14 switches an on time frame of the transistor 12 in two stages by changing a duty of the PWM signal. That is, until the battery voltage reaches a certain reference value from the start of the charge, the duty of the PWM signal is set to 70%, for example, to lengthen the on time frame of the transistor 12. When the battery voltage reaches the reference value the duty of the PWM signal is changed to 30%, for example, to shorten the on time frame of the transistor 12.

Therefore, a large amount of discharge current passes through the resistor 11, because the on time frame of the transistor 12 is lengthened at the low-battery-voltage stage soon after the charge is started. As a result, the charge of the battery having the high voltage is suppressed while the battery having the low voltage is preferentially charged, so that the variation in voltage among the batteries can be corrected to equalize the voltage at each of the batteries 21. On the other hand, at the high-battery-voltage stage after a sufficient time elapses from the start of the charge, the on time frame of the transistor 12 is shortened to decrease a discharge current passing through the resistor 11 (since the voltages are equalized at this stage, no trouble is generated even if the discharge current decreases). As a result, power consumption decreases at the resistor 11 to suppress heat generation of the resistor 11. Accordingly, a resistor having a small rated power can be used as the resistor 11.

As described above, in the present embodiment, a large amount of discharge current is allowed to pass through the resistor 11 when the battery 21 has the low voltage, and the discharge current passing through the resistor 11 is reduced when the voltage at the battery 21 is increased. Therefore, the voltages at the batteries 21 can be equalized for a short period of time while the resistor 11 having the small rated power is used.

The rated power of the resistor 11 will be described below with a specific example. At first the case that the discharge current is not changed (conventional system) is discussed. For example, an ambient temperature is 85° C., a temperature caused by self-heating of the resistor 11 is 15° C., and the temperature at the resistor 11 is set to 85° C.+15° C.=100° C. for the sake of convenience. For example, the discharge current passing through the resistor 11 is set to 0.1 [A] irrespective of the voltage (hereinafter referred to as a “cell voltage”) at the battery 21.

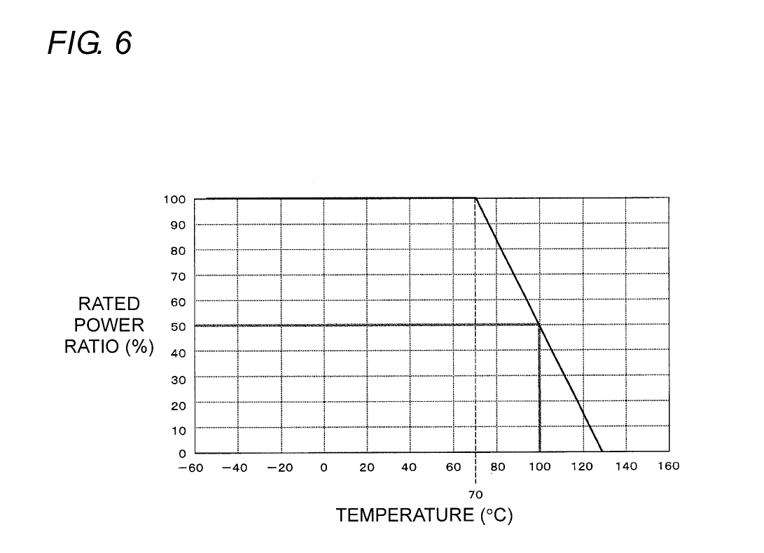

For example, in the case of the cell voltage of 2.5 [V] under the above conditions, the power consumption is 2.5 [V]×0.1 [A]=0.25 [W] at the resistor 11. When the resistor 11 has a load reduction curve in FIG. 6, a rated power ratio is 50% at the resistor temperature of 100° C. That is, because of rated power×50%=0.25 [W], it is necessary to use the resistor having the rated power of 0.5 [W] as the resistor 11.

For example, in the case of the cell voltage of 4.0 [V], the power consumption is 4.0 [V]×0.1 [A]=0.4 [W] at the resistor 11. That is, because of rated power×50%=0.4 [W], it is necessary to use the resistor having the rated power greater than or equal to 0.8 [W], namely, the rated power of 1.0 [W] as the resistor 11.

Accordingly, in the conventional system, it is necessary to eventually select the resistor 11 having the rated power of 1.0 [W].

Then the case that the discharge current is changed is discussed. For example, an ambient temperature is 85° C., a temperature caused by self-heating of the resistor 11 is 15° C., and the temperature at the resistor 11 is set to 85° C.+15° C.=100° C. for the sake of convenience. For example, the discharge current passing through the resistor 11 is set to 0.1 [A] in the case of the cell voltage of 2.5 [V], and the discharge current is set to 0.06 [A] in the case of the cell voltage of 4.0 [V].

In the case of the cell voltage of 2.5 [V] under the above conditions, the power consumption is 2.5 [V]×0.1 [A]=0.25 [W] at the resistor 11. At the resistor temperature of 100° C., the rated power ratio of 50% is obtained from the load reduction curve in FIG. 6. That is, because of rated power×50%=0.25 [W], it is necessary to use the resistor having the rated power of 0.5 [W] as the resistor 11 (this is identical to the conventional system).

On the other hand, in the case of the cell voltage of 4.0 [V], the power consumption is 4.0 [V]×0.06 [A]=0.24 [W] at the resistor 11. That is, because of rated power×50%=0.24 [W], it is necessary to use the resistor having the rated power greater than or equal to 0.48 [W], namely, the rated power of 0.5 [W] as the resistor 11.

Accordingly, in one or more embodiments of the present invention, the resistor 11 having the rated power of 0.5 [W] may be eventually selected. Therefore, the cost can be reduced by the use of the resistor having the small rated power.

Next, the detailed charge control performed by the charge control device 1 will be described below with reference to a flowchart.

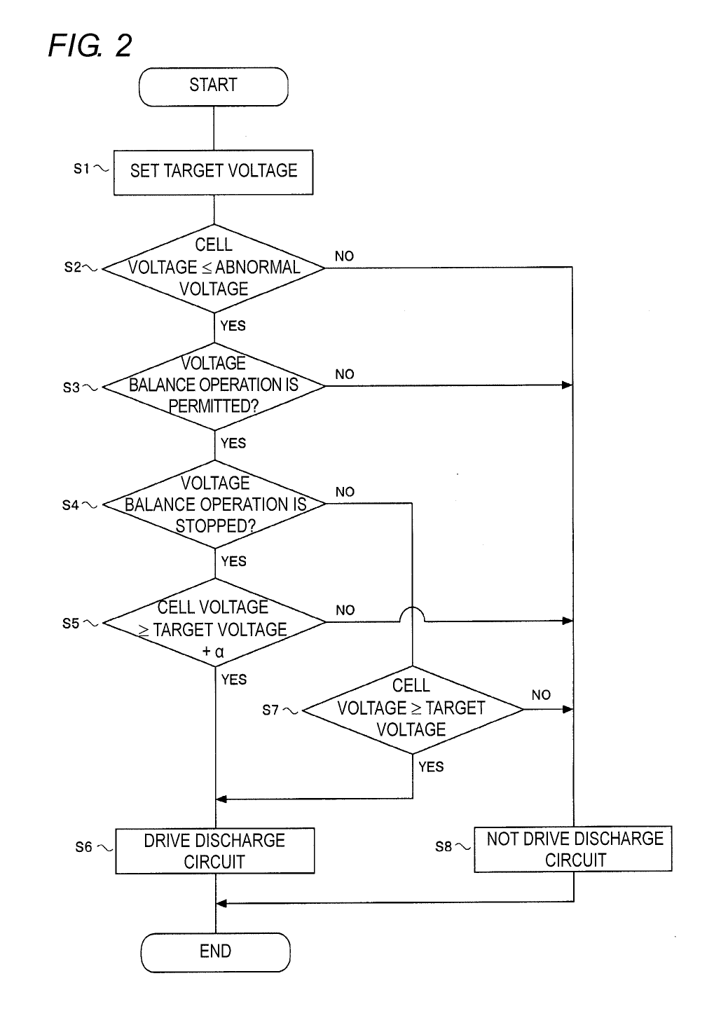

FIG. 2 is a flowchart illustrating a charge control procedure. Each step in the flowchart is performed by a CPU constituting the controller 14. Hereinafter, the controller 14 performs on/off control to each transistor 12 to equalize the voltage at each battery 21 is referred to as a “voltage balance operation”.

In Step S1, a target voltage is set based on the cell voltage at each battery 21. For example, the target voltage is set to the lowest cell voltage of the cell voltages detected by the voltage detection circuit 13. However, there is no limitation to the target voltage setting method. For example, an average value of the cell voltages may be set to the target voltage as described in Japanese Unexamined Patent Publication No. 2000-83327.

In Step S2, whether the cell voltage is less than or equal to an abnormal voltage is determined in each battery 21. The abnormal voltage means a high voltage, which is equivalent to a voltage (that is higher than the voltage at the full charge) when the battery 21 is excessively charged. When the cell voltage exceeds the abnormal voltage as a result of the determination (NO in Step S2), the determination that the battery 21 is abnormal is made, and the flow goes to Step S8 not to drive the discharge circuit 10 corresponding to the battery 21. In this case, the transistor 12 of the discharge circuit 10 is kept in the off state. On the other hand, when the cell voltage is less than or equal to the abnormal voltage (YES in Step S2), the determination that the battery 21 is normal is made, and the flow goes to Step S3.

In Step S3, whether the voltage balance operation is permitted is determined. The determination is made based on the existence or non-existence of a permission instruction from the superior apparatus. For example, the voltage balance operation is prohibited when an automobile runs, and the voltage balance operation is permitted when the assembled battery 2 is charged while the automobile is stopped. When the voltage balance operation is not permitted as a result of the determination (NO in Step S3), the flow goes to Step S8 not to drive the discharge circuit 10. On the other hand, when the voltage balance operation is permitted (YES in Step S3), the flow goes to Step S4.

In Step S4, whether the voltage balance operation is stopped is determined. When the voltage balance operation is stopped as a result of the determination (YES in Step S4), the flow goes to Step S5.

In Step S5, the cell voltage and target voltage+α are compared in each battery 21. Here, α is a constant value. For the battery of cell voltage≧target voltage+α (YES in Step S5), the determination that it is necessary to suppress the charge is made, and the flow goes to Step S6. For the battery of cell voltage<target voltage+α (NO in Step S5), the determination that it is not necessary to suppress the charge is made, and the flow goes to Step S8.

In Step S6, the voltage balance operation is performed by driving the discharge circuit 10 corresponding to the battery 21 that needs the suppression of the charge. That is, the controller 14 provides the PWM signal to the transistor 12 of the discharge circuit 10, and the transistor 12 is turned on only for the time frame determined by the duty of the PWM signal. The battery 21 is discharged through the discharge circuit 10 during the on time frame. Note that, as will be described later, the on time frame of the transistor 12 is switched according to the cell voltage.

On the other hand, when the voltage balance operation is performed (NO in Step S4), the flow goes to Step S7.

In Step S7, the cell voltage and the target voltage are compared in each battery 21. For the battery of cell voltage≧target voltage (YES in Step S7), the determination that it is necessary to suppress the charge is made, and the flow goes to Step S6. For the battery of cell voltage<target voltage (NO in Step S7), the determination that it is not necessary to suppress the charge is made, and the flow goes to Step S8.

While the voltage balance operation is not performed (YES in Step S4), when the voltage at one of the batteries 21 becomes greater than or equal to target voltage+α (YES in Step S5), the transistor 12 corresponding to the battery 21 is on for a predetermined time frame to allow the battery 21 to discharge (Step S6). While the voltage balance operation is performed (NO in Step S4), when the voltage at the batteries 21 corresponding to the transistor 12 being on for a predetermined time frame becomes less than the target voltage (NO in Step S7), the transistor 12 corresponding to the battery 21 is turned off to stop the discharge of the battery 21 (Step S8). The voltages at batteries 21 are equalized by repeating the above operation.

In the present embodiment, when the discharge circuit 10 is driven in Step S6, the duty of the PWM signal is changed between 70% and 30% according to the cell voltage. However, the values of the duty are cited by way of example. Other values may be used.

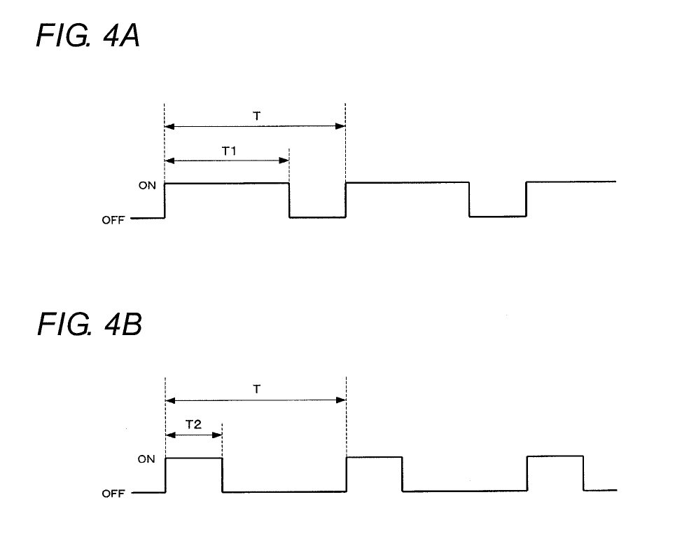

FIG. 4A illustrates a waveform of the PWM signal having the duty of 70%. T1/T=70% is obtained, where T is one period of the signal and T1 is the on time frame (during which the signal is at the H level). The on time frame T1 corresponds to a “first time frame” of one or more embodiments of the present invention. FIG. 4B illustrates a waveform of the PWM signal having the duty of 30%. T2<T1 and T2/T=30% are obtained, where T is one period of the signal and T2 is the on time frame. The on time frame T2 corresponds to a “second time frame” of one or more embodiments of the present invention. The transistor 12 is in the on state during the on time frames T1 and T2 of the PWM signal.

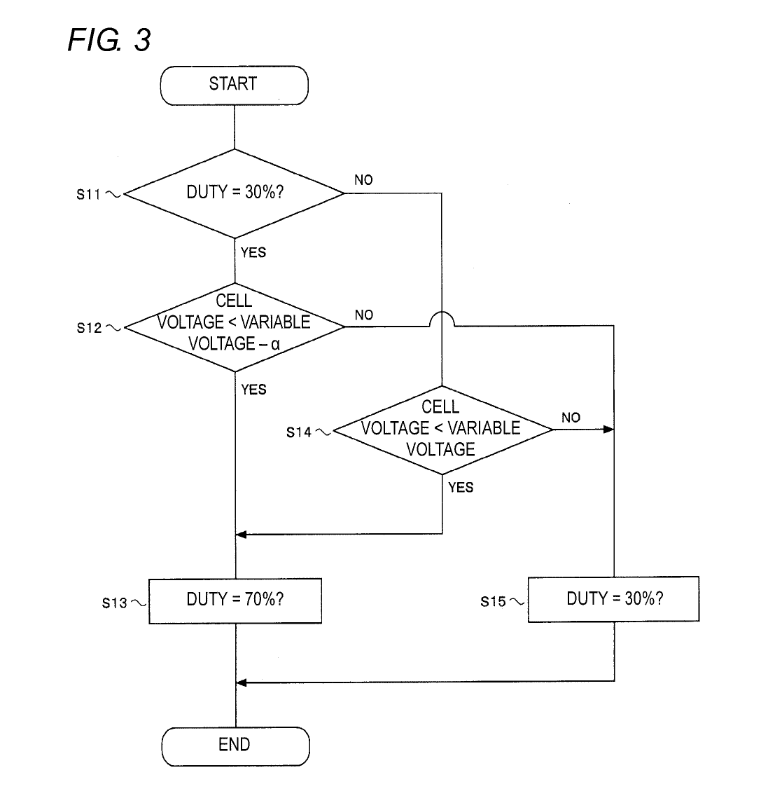

FIG. 3 is a flowchart illustrating a procedure to switch the duty of the PWM signal when the discharge circuit 10 is driven in Step S6 in FIG. 2. Each step in the flowchart is performed by a CPU constituting the controller 14.

In Step S11, whether the PWM signal has the duty of 30% is determined. The duty of the PWM signal is set to 70% immediately after the charge is started (NO in Step S11), the flow goes to Step S14.

In Step S14, the cell voltage is compared to a variable voltage. As used herein, for example, the variable voltage means a voltage that is about 80% of the voltage in the fully-charged state. In the case where the cell voltage is a high voltage near the variable voltage, the passage of the large discharge current through the resistor 11 generates the power consumption exceeding a tolerance in the resistor 11, which possibly causes burnout of the resistor 11. However, since the cell voltage is low for a while after the charge is started, cell voltage<variable voltage is obtained (YES in Step S14). Accordingly, the flow goes to Step S13 to maintain the PWM signal at the duty of 70%. The variable voltage in Step S14 corresponds to the “first reference voltage” of one or more embodiments of the present invention.

On the other hand, the cell voltage rises with the progress of the charge. In the case of cell voltage variable≧voltage (NO in Step S14), it is necessary to restrict the discharge current passing through the resistor 11. Therefore, the flow goes to Step S15 to switch the PWM signal to the duty of 30%. This shortens the on time frame of the transistor 12 to reduce the discharge current passing through the resistor 11. Therefore, the power consumption of the resistor 11 is suppressed.

When the PWM signal has the duty of 30% (YES in Step S11), the flow goes to Step S12.

In Step S12, the cell voltage is compared with variable voltage−α (α is the above constant value). In the case of cell voltage variable≧voltage−α as a result of the comparison (NO in Step S12), the determination that it is necessary to continuously restrict the discharge current passing through the resistor 11 is made, and the flow goes to Step S15 to maintain the PWM signal at the duty of 30%. Furthermore, in the case of cell voltage<variable voltage−α (YES in Step S12), the determination that it is not necessary to restrict the discharge current passing through the resistor 11 is made, and the flow goes to Step S13 to switch the PWM signal to the duty of 70%. The variable voltage−α in Step S12 corresponds to the “second reference voltage” of one or more embodiments of the present invention.

Various embodiments other than the above embodiments can be made in the present invention. For example, in the procedure in FIG. 2, Steps S2 to S8 include the step (Steps S2, S5, and S7) of performing the processing in each battery 21. Alternatively, after Steps S2 to S8 are performed with respect to one battery, Steps S2 to S8 may be performed again with respect to the next battery.

Further, in the embodiment, the transistor 12 is used as the switching element of the discharge circuit 10. Alternatively, an FET may be used instead of the transistor.

Furthermore, in the embodiment, the voltage detection circuit 13 is provided independently of the controller 14. Alternatively, the voltage detection circuit 13 may be incorporated in the controller 14.

Still furthermore, in the embodiment, by way of example, the present invention is applied to the assembled battery mounted on the electric automobile. However, the present invention can also be applied to assembled batteries used in the applications except the electric automobile.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An assembled-battery charge control device that controls charge of an assembled battery including a plurality of secondary batteries connected in series, the assembled-battery charge control device comprising:
a discharge circuit that includes a series circuit of a resistor and a switching element, the series circuit being connected in parallel with each battery of the assembled battery, the discharge circuit allowing the battery corresponding to the switching element to discharge by turning on the switching element;
a voltage detection unit that detects a voltage at each battery of the assembled battery;
and a control unit that determines the battery that needs suppression of the charge based on the voltage at each battery detected by the voltage detection unit, and turns on the switching element corresponding to the battery, wherein
the control unit, when the voltage at the battery that needs the suppression of the charge is less than a predetermined reference voltage, puts the switching element corresponding to the battery into an on state for a first time frame and
the control unit, when the voltage at the battery that needs the suppression of the charge is greater than or equal to the reference voltage, puts the switching element corresponding to the battery into the on state for a second time frame shorter than the first time frame.

2. The assembled-battery charge control device according to claim 1, wherein
the control unit controls the switching element using a PWM signal, and the control unit switches between the first time frame and the second time frame by changing a duty of the PWM signal.

3. The assembled-battery charge control device according to claim 1, wherein
the control unit:
sets a target voltage based on the voltage at each battery detected by the voltage detection unit;
puts, when the voltage at one of the batteries is greater than or equal to a voltage, in which a constant value is added to the target voltage, while the control unit does not perform on/off control to each switching element, the switching element corresponding to the battery into the on state for the first or second time frame; and
turns off, when the voltage at the battery corresponding to the switching element that is in the on state for the first or second time frame is less than the target voltage while the control unit performs the on/off control to each switching element, the switching element corresponding to the battery.

4. The assembled-battery charge control device according to claim 1, wherein
the reference voltage includes a first reference voltage and a second reference voltage lower than the first reference voltage,
the control unit
switches, when the voltage at the battery corresponding to the switching element in which the on time frame is the first time frame is greater than or equal to the first reference voltage, an on time frame of the switching element to the second time frame and
switches, when the voltage at the battery corresponding to the switching element in which the on time frame is the second time frame is less than the second reference voltage, the on time frame of the switching element to the first time frame.

5. An assembled-battery charge control method for controlling charge of an assembled battery including a plurality of secondary batteries connected in series, a discharge circuit including a series circuit of a resistor and a switching element being connected in parallel with each battery of the assembled battery, the assembled-battery charge control method comprising:
detecting a voltage at each battery of the assembled battery;
determining a battery that needs suppression of the charge based on the detected voltage at each battery;
putting, when the voltage at the battery that needs the suppression of the charge is less than a predetermined reference voltage, the switching element corresponding to the battery into an on state for a first time frame; and
putting, when the voltage at the battery that needs the suppression of the charge is greater than or equal to the reference voltage, the switching element corresponding to the battery into the on state for a second time frame shorter than the first time frame.
